(19) United States
(12) Patent Application Publication
(10) Pub. No.: US 2013/0278407 A1
(43) Pub. Date: Oct. 24, 2013

(54) FUEL FILL COST CALCULATION FOR A VEHICLE

(71) Applicant: LEIGH M. ROTHSCHILD, SUNNY ISLES BEACH, FL (US)

(72) Inventor: LEIGH M. ROTHSCHILD, SUNNY ISLES BEACH, FL (US)

(73) Assignee: ARIEL INVENTIONS, LLC, Sunny Isles Beach, FL (US)

(21) Appl. No.: 13/450,779

(22) Filed: Apr. 19, 2012

(51) Int. Cl. B60Q 1/00

(52) U.S. Cl. 340/450.2

(57) ABSTRACT

Indicating a cost to fill a fuel tank of a vehicle. A signal indicating a level fuel contained in the fuel tank of the vehicle can be received from a fuel sending unit. Based on the level of fuel contained in the fuel tank, a quantity of fuel required to fill the fuel tank can be determined. Fuel data can be received. Based on the quantity of fuel required to fill the fuel tank and the fuel data, a cost to fill the fuel tank can be received. A visual indicator indicating the cost to fill the fuel tank can be presented.

### BACKGROUND

One or more embodiments disclosed within this specification relate to calculating a cost to fill a fuel tank with fuel.

Automobiles usually include a fuel gauge located within an instrument cluster in the automobile's dashboard. When the vehicles ignition is turned on, the fuel gauge receives a signal from a fuel level sending unit located in the fuel tank that indicates the quantity of fuel contained in the fuel tank, and the fuel gauge displays the fuel level. When the vehicle's ignition is off, the fuel level sending unit typically does not receive power, and thus does not generate a signal. Hence, the fuel gauge does not display the fuel level when the ignition is off.

A typical fuel level sending unit includes a float, usually made of a coated foam substance, which floats on top of the fuel contained in the fuel tank. The float typically is attached to a swing arm, which is attached to a variable resistor. The orientation of the swing arm, and thus the amount of resistance provided by the variable resistor, is directly related to the position of the float. In illustration, when the ignition is on, an input voltage (typically DC voltage) is applied to the variable resistor, and an output voltage from the variable resistor is communicated to the fuel level gauge. This output voltage is variable, based on the amount of resistance provided by the variable resistor, and indicates the current level of fuel contained in the fuel tank.

### BRIEF SUMMARY

One or more embodiments disclosed within this specification relate to a method of indicating a cost to fill a fuel tank of a vehicle. The method can include receiving from a fuel level sending unit a signal indicating a level fuel contained in the fuel tank of the vehicle. Based on the level of fuel contained in the fuel tank, via a processor, a quantity of fuel required to fill the fuel tank can be determined. The method also can include receiving fuel data. Based on the quantity of fuel required to fill the fuel tank and the fuel data, the cost to fill the fuel tank can be determined. A visual indicator indicating the cost to fill the fuel tank can be presented.

Another embodiment can include a system that includes at least one memory and a processor. The processor can be configured to initiate executable operations including receiving from a fuel level sending unit a signal indicating a level fuel contained in the fuel tank of the vehicle, based on the level of fuel contained in the fuel tank, determining a quantity of fuel required to fill the fuel tank, receiving fuel data, based on the quantity of fuel required to fill the fuel tank and the fuel data, determining the cost to fill the fuel tank, and presenting a visual indicator indicating the cost to fill the fuel tank.

Another embodiment can include a computer program product that includes a computer-usable storage medium having stored therein computer-usable program instructions for indicating a cost to fill a fuel tank of a vehicle. The computer-usable program instructions that, when executed by a computer hardware system, causes the computer hardware system to perform the various operations and/or functions disclosed within this specification.

### BRIEF DESCRIPTION OF THE SEVERAL VIEWS OF THE DRAWINGS

FIG. 1 is a block diagram illustrating a system for indicating a cost to fill up a vehicle's fuel tank in accordance with one embodiment disclosed within this specification.

FIG. 2 is diagram illustrating a portion of a vehicle that includes the system of FIG. 1 in accordance with one embodiment disclosed within this specification.

FIG. 3 is diagram illustrating a portion of a vehicle that includes the system of FIG. 1 in accordance with one embodiment disclosed within this specification.

FIG. 4 is diagram illustrating a processing system in accordance with one embodiment disclosed within this specification.

FIG. 5 is a flow chart illustrating a method of indicating a level of fuel contained in a fuel tank of a vehicle in accordance with one embodiment disclosed within this specification.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

In accordance with the arrangements described herein, a fuel level monitoring system can be incorporated into a vehicle to visually indicate to a person the approximate cost to fill the vehicle's fuel tank. The cost can be calculated based on the amount of additional fuel capacity remaining in the fuel tank and the price of the fuel. The price of the fuel can be entered by a user or automatically obtained from a fueling station. For example, the fueling station can wirelessly communicate data, such as fuel prices, a grade of fuel (e.g., fuel octane level) and/or other data related to the fuel, to the vehicle, in which case vehicle can include a transceiver or receiver to receive such communication. In another example, fueling station can post an alphanumeric characters corresponding to the fuel data, in which case the vehicle can include an alphanumeric character reader that optically detects the alphanumeric characters. In another example, the fueling station can post a machine-readable representation of data, such as a barcode, corresponding to the fuel data, in which case the vehicle can include a data reader that optically detects the machine-readable representation of data. A barcode can be a universal product code (UPC), a matrix barcode (e.g., a quick response (QR) code), or any other optical machine-readable representation of data. In another arrangement, the fueling station can post fuel data on a website, and the fuel data can be automatically retrieved from the website, for example using a web-enabled device.

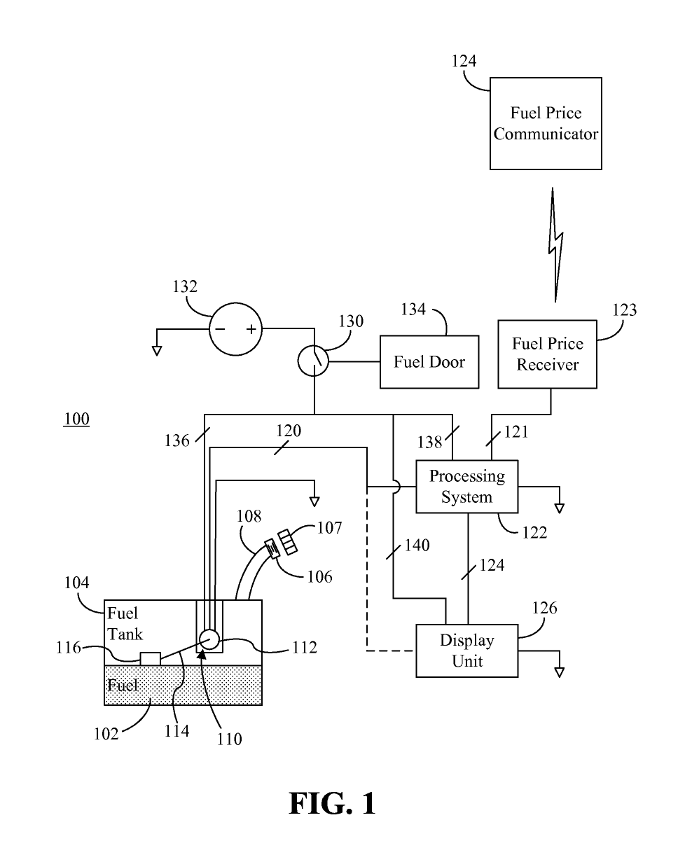

FIG. 1 is a block diagram illustrating a system 100 for indicating a cost to fill up the vehicle's fuel tank in accordance with one embodiment disclosed within this specification. The system 100 can be implemented within a vehicle, such as an automobile, a truck, a tractor, farming equipment, industrial equipment, an aircraft, a boat, or the like.

The system 100 can include a fuel level sending unit (hereinafter “sending unit”) 110 that measures a level of fuel 102 within a fuel tank 104. A fuel nozzle 106 that receives fuel 102 being added to the fuel tank 104 can be operably connected to the fuel tank 104, for example via a spout 108.

In one non-limiting example, the sending unit 110 can be a conventional sending unit known in the art that comprises a variable resistor 112, a swing arm 114, and a float 116. A first end of the swing arm 114 can be attached to the variable resistor 112 and a second end of the swing arm 114 can be attached to the float 116. The float 116 can be configured to float on top of the fuel 102. An orientation of the swing arm 114 can correspond to the location of the float, and thus the level of fuel 102 contained in the fuel tank 104. The resistance provided by the variable resistor 112 can correspond to the orientation of the swing arm 114. A fuel level signal 120 corresponding to the resistance can be generated by the sending unit 110.

In another example, the sending unit 110 can include an optical sensor that measures the level of fuel 102 contained in the fuel tank 104. In yet another example, the sending unit 110 can include an ultrasonic sensor that measures the level of fuel 102 contained in the fuel tank 104. Still, the invention is not limited to these examples; the sending unit 110 can include any sensor(s) or device(s) suitable for measuring the level of fuel 102 contained in the fuel tank 104, and any such sensor(s) or device(s) are within the scope of the present invention.

In one embodiment, the sending unit 110 can be configured to communicate the fuel level signal 120 to a processing system 122 to indicate the level of fuel 102 presently contained in the fuel tank 104. As fuel 102 is added to, or removed from, the fuel tank 104, the fuel level signal 120 can continually indicate a present level of fuel 102, even as the level of fuel 102 changes. In other words, as the fuel level increases, the fuel level signal 120 will change accordingly. Similarly, as the fuel level decreases, the fuel level signal 120 will change accordingly. The fuel level signal 120 can be an analog signal (e.g., a DC voltage, an AC voltage, or the like), a digital signal, or any other type of signal suitable for communicating a present level of fuel 102 contained in the fuel tank 104.

The system 100 further can include a fuel data receiver 123, such as a radio frequency (RF) transceiver, an RF receiver, an infrared (IR) detector and/or a data reader, that receives and/or otherwise detects the price of fuel at a fueling station. The fueling station can include a fuel data communicator 124 that communicates the price of fuel at the fueling station. In one arrangement, the fuel data communicator 124 can be an RF transceiver or RF transmitter that transmits a wireless RF signal corresponding to the fuel data, and the fuel data receiver 123 can receive and process such RF signal. In another arrangement, the fuel data communicator 124 can comprise alphanumeric characters indicating the fuel data. The alphanumeric characters can be, for example, attached to a fuel pump or presented by the fuel pump in any suitable manner, for example via a display. In such case, the fuel data receiver 123 can be a data reader configured to scan the alphanumeric characters to identify the fuel data. The display can be an LED display, an LCD display, a mechanical display that is configured to selectively present certain alphanumeric characters, or any other display via which alphanumeric characters can be presented. In yet another arrangement, the fuel data communicator 124 can comprise a machine-readable representation of data corresponding to the fuel data. The machine-readable representation of data can be, for example, attached to a fuel pump. In such case, the fuel data receiver 123 can be a data reader configured to scan the machine-readable representation of data to identify the fuel data. As noted, the machine-readable representation of data can be a barcode, although the present system is not limited in this regard.

In another arrangement, the fuel data communicator 124 can be a website that posts the price of fuel, and the fuel data receiver 123 can be a web-enabled device or system suitably configured to retrieve the fuel data from the website. For example, the fuel data receiver 123 can be configured to access the website over a WiFi™ communication link, a cellular communication link, or in any other suitable manner. In this regard, the fuel data receiver 123 can be a web-enabled device integrated into the vehicle, such as the processing system 122 or another computing device communicatively linked to the processing system 122. In another embodiment, the web-enabled device can be a smart phone, a tablet computer, mobile computer, an application specific device, or the like, communicatively linked to the processing system 122. The web-enabled device can be communicatively linked to the processing system 122 via wired connection (e.g., universal serial bus (USB), FireWire®, or the like) or a suitable wireless communication link. A suitable wireless communication link can be implemented in accordance with a wireless networking protocol, (e.g., WiFi®), implemented in accordance with a personal area network (PAN) protocol (e.g., Bluetooth® or ZigBee®), implemented in accordance with a suitable direct wireless communication protocol, implemented in accordance with a suitable infrared (IR) communication protocol, or implemented in accordance with any other suitable communication protocol.

In yet another arrangement, the fuel data communicator can display the fuel data, and a person can manually enter the fuel data into the fuel data receiver 123 via one or more user inputs. In this case, the fuel data receiver 123 can comprise a suitable user interface. In illustration, the user interface can comprise a touch screen, buttons and/or keys configured to receive user inputs. For instance, the user interface can be a component of the vehicle, for example within the vehicle's instrument cluster or infotainment system, a mobile communication device (e.g., smart phone, tablet computer, mobile computer, etc.) communicatively linked to the vehicle (e.g., to the processing system 122), or the like.

The processing system 122 can process the signal 120 and communicate a corresponding signal 125 to a display unit 126, which can present an indication of the total cost to fill the fuel tank 104. The display unit 126 can comprise a gauge or a display (e.g., LED display, LCD display, plasma display, or the like) that visually presents information, such as the information described herein. In one arrangement, the display unit 126 can be located inside the vehicle, for example in an instrument cluster or as a component of an infotainment system. In another arrangement, the display unit 126 can be external with respect to the inside of the vehicle, for example on a fuel door or attached to an external surface of the vehicle. In yet another arrangement, the display unit 126 can project an image comprising such information onto a window or other screen configured to present the information. The invention is not limited in this regard, however. For example, the display unit 126 can interface with any other suitable presentation systems/devices to present the information.

The signals 120, 125 can be communicated via respective wired communication links and/or wireless communication links. Examples of suitable wireless communication links include, but are not limited to, wireless communication links implemented in accordance with a suitable networking protocol (e.g., WiFi®), wireless communication links implemented in accordance with a PAN protocol (e.g., Bluetooth® or ZigBee®), wireless communication links implemented in accordance with a suitable direct wireless communication protocol, wireless communication links implemented in accordance with a suitable infrared (IR) communication protocol, or wireless communication links implemented in accordance with any other suitable protocol.

As noted, when a vehicle's ignition is turned off, a typical sending unit does not receive power. Moreover, a vehicle's processing system (e.g., engine control unit (ECU)) also may not receive power when the ignition is turned off. The present invention, however, can provide power to the sending unit 110, the processing system 122 and/or the display unit 126 when it is appropriate to display the cost to fill the fuel tank 104, even while the ignition remains off. For example, the system 100 can include a switch 130 operably connected to a power source, such as a battery 132, that is operable when the vehicle ignition is off.

In one arrangement, the switch 130 can be a mechanical switch physically connected to the fuel door 134 or the fuel nozzle 106. Thus, opening and closing of the fuel door 134 can physically operate the switch, or removing the fuel cap 107 from the fuel nozzle 106, or placing the fuel cap 107 on the fuel nozzle 106, can physically operate the switch. In another arrangement, a sensor (not shown) can be provided to detect when the fuel door 134 is open or closed or when the fuel cap 107 is placed on, or removed from, the fuel nozzle 106. The sensor can communicate a signal to the switch to cause the switch to open or close. Further, the switch can be integrated into the processing system 122. In this regard, the switch 130 can be an electronic switch, such as a transistor, an operational amplifier, or the like.

The switch 130 can be configured to be in an open position (or non-conducting of current) when a fuel door on the vehicle covering the fuel nozzle 106 is closed, or when a fuel cap 107 is positioned on the fuel nozzle 106. The switch 130 can be configured to be in a closed position (or conducting of current) when the fuel door 134 is open, or when a fuel cap 107 is removed from the fuel nozzle 106.

When in the closed position, the switch 130 can close a circuit connection 136 between the battery 132 and the sending unit 110, thereby providing electrical power (hereinafter “power”) to the sending unit. If the processing system 122 normally does not receive power when the vehicle's ignition is off, when in the closed position the switch 130 also can close a circuit connection 138 between the battery 132 and the processing system 122, thereby providing power to the processing system 122. Further, in an arrangement in which the display unit 126 requires power from the battery 132 to operate, when in the closed position, the switch 130 also can close a circuit connection 140 between the battery 132 and the display unit 126, thereby providing power to the display unit 126.

Accordingly, the display unit 126 can present an indication of the cost to fill the fuel tank 104 when the vehicle's ignition is off. In illustration, when the fuel door 134 is opened, or when the fuel cap 107 is removed from the fuel nozzle 106, the switch 130 can close to activate the sending unit 110, the processing system 122 and/or the display unit 126.

When activated, the sending unit 110 can communicate the fuel level signal 120 to the processing system, which can process the fuel level signal 120 to communicate a corresponding fuel cost signal 125 to the display unit 126. In response to receiving the fuel cost signal 125, the display unit 126 can present a visual indicator indicating the cost to fill the fuel tank 104.

The processing system 122 can, based on the present fuel level indicated by the sending unit 110, determine the amount, or quantity, of fuel 102 contained in the fuel tank 104. The processing system 122 can subtract a value corresponding to the quantity of fuel 102 from a value corresponding to the total quantity of fuel that the fuel tank 104 is configured to hold in order to determine how much additional fuel 102 the fuel tank 104 can hold. The total quantity of fuel that the fuel tank 104 is configured to hold can be known to the processing system 122 a priori. For example, the processing system 122 can be pre-configured to store a value corresponding to the maximum quantity of fuel 102 held by the fuel tank 104 within a suitable data storage device. The processing system 122 can multiply the price charged by the fueling station for the fuel by the quantity of additional fuel 102 the fuel tank 104 can hold to determine the total cost to fill the fuel tank 104.

Fueling stations oftentimes offer different grades, or qualities, of fuel (e.g., octane level), each grade having its own price. The fuel data communicator 124 can communicate each of such fuel grades and corresponding fuel prices to the fuel data receiver 123. The processing system 122 can identify the grade of fuel typically used by the vehicle, and identify the corresponding price for that grade of fuel to use in the computations to determine the cost to fill the vehicle's fuel tank 104 with fuel 102. The quality of fuel recommended for the vehicle can be known to the processing system 122 a priori. For example, the processing system 122 can be pre-configured and store a value corresponding to such recommendation within a suitable data storage device. That said, the processing system 122, or another processing system within the vehicle (e.g., an ECU or engine management system (EMS) communicatively linked to the processing system 122), may detect an unacceptable level of detonation and/or pre-ignition in the vehicle's engine, for example by processing a signal received from a knock sensor. If detonation and/or pre-ignition is detected, the processing system 122 can increase the value corresponding to the recommended quality of fuel, for example by increasing a recommended fuel octane level to a next higher octane level commonly available in fueling stations. The processing system 122 can indicate the desired grade of fuel via the display unit 126 to alert the user as to which grade of fuel is recommended.

In one embodiment, as fuel is added to the fuel tank the total cost to fill the fuel tank can remain fixed based on the level of fuel contained in the fuel tank prior to the fueling operation commencing. For example, the level of fuel contained in the fuel tank when the vehicle's ignition is turned off can be stored in the processing system 122. In this arrangement, the fuel sending unit need not be turned on in order for the processing system 122 to determine the cost to fill the fuel tank 104, and the switch 130 need not provide power to the sending unit 110 when the vehicle's ignition is off. In another embodiment, the cost to fill the tank can be continually updated as fuel is added to the fuel tank 104 to reflect the changing level of fuel 102 in the fuel tank 104. Accordingly, when the cost reaches “$0.00,” a person filling the fuel tank 104 can be assured that the fuel tank 104 is filled.

In addition to, or in lieu of, the cost to fill the fuel tank 104, other information can be presented by the display unit 126. In illustration, the display unit 126 can indicate the quantity of fuel necessary to fill the fuel tank 104, the present level of fuel 102 in the fuel tank 104, the energy efficiency of the vehicle, the approximate distance the vehicle can travel based on the present fuel level, an amount of time the vehicle can operate based on the present fuel level, the grade, or quality, of fuel recommended for the vehicle, and so on. Such information can be determined by the processing system 122 and communicated to the display unit 126, for example as previously described.

A toggle button, touch screen or sensor can be provided to allow a person to change the information presented by the display unit 126. For example, in one arrangement, if the display unit 126 is accessible to the person while the person is located externally of the vehicle, the display unit 126 can include a toggle button or touch screen that receives tactile inputs from the person to change the information presented by the display unit 126. In another arrangement, the display unit 126 can include an optical sensor (e.g., an imaging device, such as a camera, a motion detector, etc.) that detects gestures provided by the person (e.g., hand or lip movements) to change the information presented by the display unit 126, or an input audio transducer receives spoken utterances generated by the user to change the information presented by the display unit 126. Toggle buttons and touch screens that receive tactile inputs, and sensors that detect gestures and/or spoken utterances, are known in the art.

To determine a distance-based energy efficiency of the vehicle, the processing system 122 can identify a distance the vehicle has traveled over a particular period and divide that amount by the quantity of fuel consumed by the vehicle over that period. In one arrangement, the period can span a time from when fuel last was added to the fuel tank 104 to a present time, though this need not be the case. The energy efficiency can be identified as a value corresponding to miles per gallon (MPG), kilometers per liter (KPL), miles per liter, kilometers per gallon, or as a value corresponding to any other distance-based fuel efficiency measurement. To determine the distance the vehicle can travel based on the present fuel level, the processing system 122 can multiply the value corresponding to the total quantity of fuel 102 presently contained in the fuel tank 104 by a value corresponding to the vehicles distance-based energy efficiency.

To determine a time-based energy efficiency of the vehicle, the processing system 122 can identify the time the vehicle has been operated over a particular period and divide the quantity of fuel consumed by the vehicle over that period by the identified time. Again, the period can span a time from when fuel last was added to the fuel tank 104 to a present time, though this need not be the case. The energy efficiency can be identified as a value corresponding to gallons per hour (GPH), liters per hour (LPH), or as a value corresponding to any other time-based fuel efficiency measurement. To determine the amount of time the vehicle can operate based on the present fuel level, the processing system 122 can divide the value corresponding to the total quantity of fuel presently contained in the fuel tank 104 by a value corresponding to the vehicles energy efficiency.

In a further arrangement, the fuel data receiver 123 can be configured to can access data from one or more websites pertaining to geographic locations of multiple fueling stations and prices for fuel offered by those fueling stations, as well as other data related to the fueling stations, such as brands, hours of operation, distance from the vehicle's current location (e.g., using GPS), and the like. Accordingly, a user can select any of such fueling stations, for example by entering a user input into a user selectable menu of the display unit 126 (or another display) or selecting a fueling station on a map presented on the display unit 126 (or another display). Upon the user selecting a particular fueling station, the display unit 126 or other display can present data indicating the price of fuel at the selected fueling station and/or the cost to fill the fuel tank 104 if the user were to purchase fuel from the selected fueling station. The other display can be a mobile communication device communicatively linked to the vehicle (e.g., to the processing system 122), for example via a wired communication link or a wireless communication link.

The fueling stations that are identified can be those that are geographically proximate to the present location of the vehicle, for example within a specific distance from the vehicle (e.g., ½ mile, 1 mile, 2 miles, 3 miles, 4 miles, 5 miles, 10 miles, etc.). The distance can be a user selectable parameter. The processing system 122 can determine the distance to each fueling station verses the cost of the fuel provided by each respective fueling station to determine whether it is cost effective to choose one fueling station over another. In illustration, the processing system 122 can determine the approximate amount of fuel that will be used by the vehicle to travel to each one of the respective fueling stations. For each fueling station, based on the amount of fuel that will be used, the vehicle's gas mileage (e.g., miles per gallon or kilometers per liter) and the cost of the fuel (either at each respective fueling station or an average cost of fuel), the processing system 122 can estimate an approximate cost of the fuel that will be used for the vehicle to travel from its present location to the fueling station. For each fueling station, the processing system 122 can add the cost of fuel that will be used to travel to the fueling station to the cost of filling the fuel tank 204 at that fueling station to determine a total cost. Based on the total cost associated with purchasing fuel at each fueling station, the processing system 122 can present a recommendation on the display unit 126 or another display unit on which fueling station is most cost effective to use (e.g., which fueling station is associated with the lowest total cost). Moreover, the processing system 122 can sort the fueling stations in a hierarchical order based on total cost, and present the sorted fueling stations on the display unit 126 or other display unit from which the user can choose. Such presentation also can indicate the cost of fuel at the fueling stations and the distance to each fueling station from the vehicle's present location.

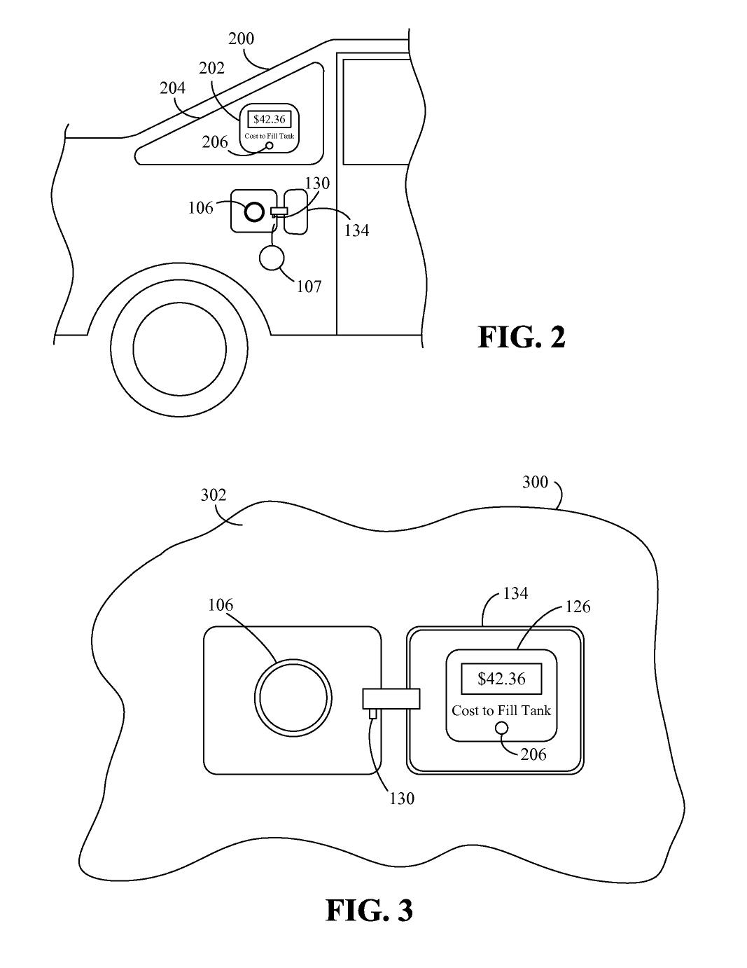

FIG. 2 is diagram illustrating a portion of a vehicle 200 that includes the system of FIG. 1 in accordance with one embodiment disclosed within this specification. As noted, the display unit can present the cost to fill the fuel tank on a window of the vehicle 200, for example a rear side window or rear quarter window 204 located on a same side of the vehicle 200 as the fuel nozzle 106. The invention is not limited to this example, however. For instance, if the fuel nozzle 106 is located at the front of the vehicle 200, the display unit can present the indication 202 of the cost to fill the fuel tank on a front window (i.e., “windshield”) of the vehicle 200, on a front quarter window or on a front side window. If the fuel nozzle 106 is located at the back side of the vehicle 200, the display unit can present the indication 202 of the cost to fill the fuel tank on the vehicle's rear window. If the cost to fill the fuel tank is indicated to the person while the person still is inside the vehicle, the display unit can present the indication 202 on the front window, for example as a heads-up display.

The indication 202 of the cost to fill the fuel tank can be presented when the fuel door 134 is open or when the fuel cap 107 is removed from the fuel nozzle 106. A switch 130, or a sensor operatively connected to a switch, can be provided to detect when the fuel door 134 is open, or when the fuel cap 107 is removed from the fuel nozzle 106. This need not be the case, however, if cost is presented to the person while the person is located inside the vehicle. In such case, the indication 202 of the cost to fill the fuel tank can be presented when the fuel door 134 is closed and/or when the fuel cap 107 is attached to fuel nozzle 106

In one embodiment the display unit can be located proximate to the window 204, for example behind or in front of the window 204, integrated into the window 204, or the display unit can project an image representing the indication 202 onto the window. As noted, any other suitable information can be displayed on the window 204, such as a fuel level indication, the quantity of fuel necessary to fill the fuel tank, the energy efficiency of the vehicle, the distance the vehicle can travel based on the present fuel level, an amount of time the vehicle can operate based on the present fuel level, and so on. A toggle button or icon 206 can be presented on the window 204 or the display unit 126 to receive tactile inputs to toggle between the various types of information to be presented by the display unit 126. In illustration, the window 204 can comprise the display unit 126, which can be embodied as a touch screen integrated into the window 204. As also noted, an input audio transducer can be provided to detect spoken utterances provided by a person to toggle between the various types of information to be presented, or optical sensor can be provided to detect lip movements or gestures provided by a person to toggle between the various types of information to be presented.

FIG. 3 is diagram illustrating a portion of a vehicle 300 that includes the system of FIG. 1 in accordance with one embodiment disclosed within this specification. The display unit 126 can be attached to the fuel door 134, the display unit 126 can be attached to an external surface 302 of the vehicle 300, or the display unit 126 can be located inside the vehicle, for example in the vehicles dashboard or infotainment system. As noted, the display unit 126 can comprise a gauge or a display. Moreover, a toggle button or icon 206 can be presented on the display unit 126 to receive tactile inputs to toggle between the various types of information to be presented by the display unit 126. Again, an input audio transducer can be provided to detect spoken utterances provided by a person to toggle between the various types of information to be presented, or optical sensor can be provided to detect lip movements or gestures provided by a person to toggle between the various types of information to be presented. Again, a switch 130, or a sensor operatively connected to a switch, can be provided to detect when the fuel door 134 is open, or when the fuel cap 107 is removed from the fuel nozzle 106. In the case that the display unit 126 is presented inside the vehicle, the switch 130 need not be used. In other words, the person can view the cost to fill the fuel tank before getting out of the vehicle to fill the fuel tank.

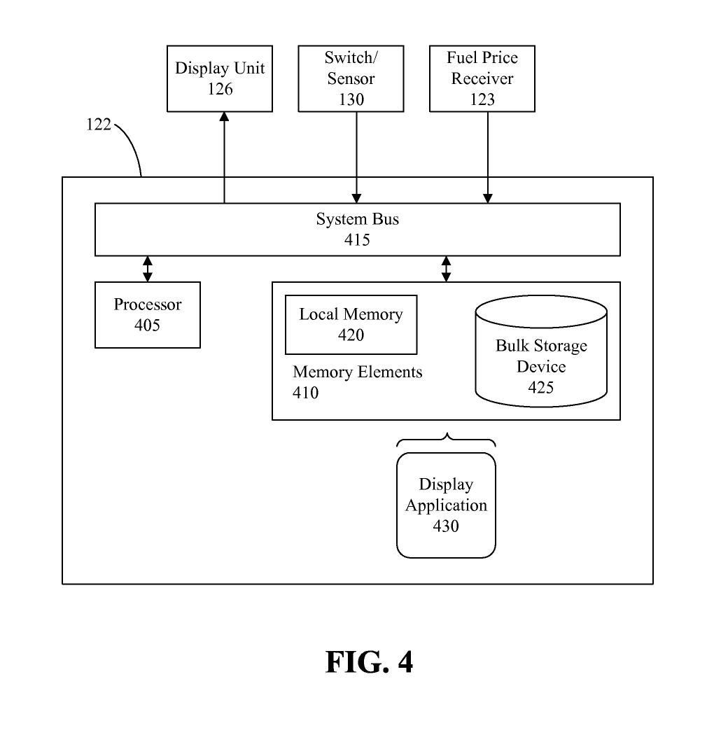

FIG. 4 is diagram illustrating a processing system 122, for example a computer hardware system, in accordance with one embodiment disclosed within this specification. The processing system 122 can include at least one processor 405 coupled to memory elements 410 through a system bus 415 or other suitable circuitry. As such, the processing system 122 can store program code within the memory elements 410. The processor 405 can execute the program code accessed from the memory elements 410 via the system bus 415. In one aspect, for example, the processing system 122 can be implemented as a computer that is suitable for storing and/or executing program code. It should be appreciated, however, that the processing system 122 can be implemented in the form of any system including a processor and memory that is capable of performing the functions and/or operations described within this specification.

The memory elements 410 can include one or more computer-usable (e.g., computer-readable) storage devices 410 such as, for example, local memory 420 and one or more bulk storage devices 425. Local memory 420 refers to random access memory or other non-persistent memory device(s) generally used during actual execution of the program code. The bulk storage device(s) 425 can be implemented as read only memory (ROM), a hard disk drive (HDD), a solid state drive (SSD) or other persistent data storage device, an erasable programmable read-only memory (EPROM or Flash memory), a portable compact disc read-only memory (CD-ROM), a digital versatile disc (DVD), an optical storage device, a magnetic storage device, or any suitable combination of the foregoing. The processing system 122 also can include one or more cache memories (not shown) that provide temporary storage of at least some program code in order to reduce the number of times program code must be retrieved from the bulk storage device 425 during execution. In the context of this document, a computer-usable storage device may be any tangible computer-usable storage medium that can contain, or store a program for use by or in connection with an instruction execution system, apparatus, or device. As used herein, a computer-usable device is non-transitory, meaning that it stores computer-usable program code for a finite period.

Input/output (I/O) devices such as the display unit 126, the switch 130 (or sensor) and the fuel data receiver 123 optionally can be coupled to the processing system 122. The I/O devices can be coupled to the processing system 122 either directly or through intervening I/O controllers.

As pictured in FIG. 4, the computer-usable (e.g., computer-readable) storage devices 410 can store a display application 430. The display application 430, being implemented in the form of executable program code, can be executed by the processing system 122 and, as such, can be considered part of the processing system 122. In this regard, the display application 430 can be executed by the processor 405 to perform the methods and processes described herein.

As will be appreciated by one skilled in the art, aspects of the present invention may be embodied as a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer-usable storage device(s) having computer-usable program code embodied therewith, e.g., stored, therein or thereon.

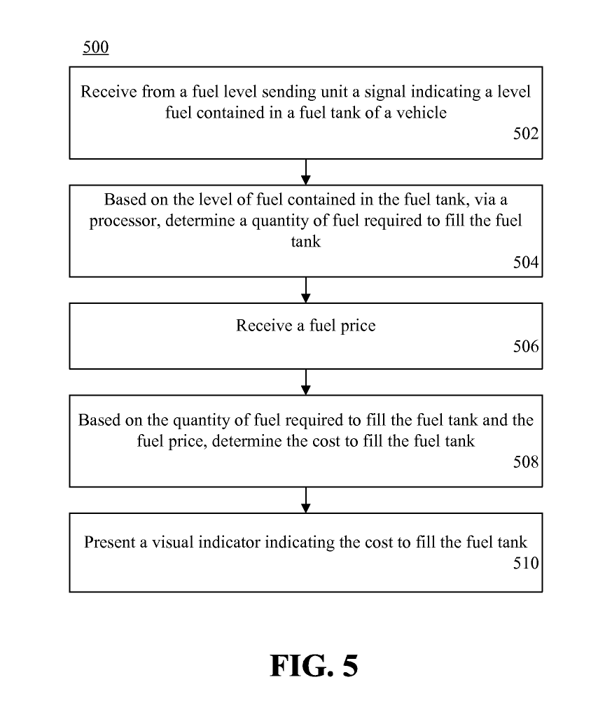

FIG. 5 is a flow chart illustrating a method 500 of indicating a cost to fill a fuel tank of a vehicle, which is useful for understanding the present invention. At step 502, a signal indicating a level fuel contained in the fuel tank of a vehicle can be received from a fuel level sending unit. At step 504, based on the level of fuel contained in the fuel tank, via a processor, a quantity of fuel required to fill the fuel tank can be determined.

At step 506, a fuel data can be received. The fuel data can correspond to the price of the fuel and/or a grade of fuel desired for use in the vehicle. In illustration, the fuel data can be received from a fuel data communicator associated with a fueling station. For example, an RF signal can be received from the fuel data communicator, wherein the RF signal indicates the fuel data. In another example, a barcode indicating the fuel data can be read, wherein the fuel data communicator comprises the barcode. In another example, the fuel data can be received from a website associated with the fueling station. In another embodiment, a user input indicating the fuel data can be received.

At step 508, based on the quantity of fuel required to fill the fuel tank and the fuel data, the cost to fill the fuel tank can be determined. At step 510, a visual indicator indicating the cost to fill the fuel tank can be presented. The visual indicator can be clearly visible to a person located outside of the vehicle while the vehicle is off. Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of indicating a cost to fill a fuel tank of a vehicle, the method comprising:
receiving from a fuel level sending unit a signal indicating a level fuel contained in the fuel tank of the vehicle;
based on the level of fuel contained in the fuel tank, via a processor, determining a quantity of fuel required to fill the fuel tank;
receiving fuel data;
based on the quantity of fuel required to fill the fuel tank and the fuel data, determining the cost to fill the fuel tank; and
presenting a visual indicator indicating the cost to fill the fuel tank.

2. The method of claim 1, wherein:
the fuel data is received from a fuel data communicator associated with a fueling station.

3. The method of claim 2, wherein:
an RF signal indicating the fuel data is received from the fuel data communicator.

4. The method of claim 2, wherein:
the receiving includes reading a machine-readable representation of data indicating the fuel data; and
the fuel data communicator comprises the machine-readable representation of data.

5. The method of claim 2, wherein:
the receiving includes reading alphanumeric characters indicating the fuel data; and
the fuel data communicator comprises the alphanumeric characters.

6. The method of claim 2, wherein:
the fuel data is received from a website associated with the fueling station.

7. The method of claim 1, wherein:
the fuel data is received via a user input indicating the fuel data.

8. The method of claim 1, wherein:
the fuel data corresponds to at least one type of data selected from a group consisting of a fuel price and a grade of fuel desired for use in the vehicle.

9. The method of claim 1, wherein:
the visual indicator is visible to a person located outside of the vehicle while the person is adjacent to a fuel receiving nozzle through which fuel is added to the fuel tank.

10. The method of claim 1, wherein:
the fuel data is received for a plurality of fueling stations;
the cost to fill the fuel tank is determined for each of the fueling stations; and
the visual indicator indicates the cost to fill the fuel tank at each of the fueling stations.

11. The method of claim 10, further comprising:
for each of the fueling stations:
determining an approximate amount of fuel that will be used by the vehicle to travel to the fuel station;
based at least on the amount of fuel, determining an approximate cost of the fuel that will be used; and
adding the approximate cost of the fuel that will be used to the cost to fill the fuel tank at that fuel station to determine a total cost associated with the fuel station; and
presenting a visual indicator indicating the total cost.

12. The method of claim 11, further comprising:
presenting a recommendation of which fueling station is associated with the lowest total cost.

13. The method of claim 11, further comprising:
sorting the fueling stations in a hierarchical order based on total cost; and
presenting a list of the fueling stations sorted in the hierarchical order.

14. The method of claim 13, wherein:
The list indicates the cost of fuel at each of the fueling distance and the distance to each fueling station from the vehicle's present location.

15. A system comprising:
at least one memory; and
a processor configured to initiate executable operations comprising:
receiving from a fuel level sending unit a signal indicating a level fuel contained in the fuel tank of the vehicle;
based on the level of fuel contained in the fuel tank, via a processor, determining a quantity of fuel required to fill the fuel tank;
receiving fuel data;
based on the quantity of fuel required to fill the fuel tank and the fuel data, determining the cost to fill the fuel tank; and
presenting a visual indicator indicating the cost to fill the fuel tank.

16. The system of claim 15, wherein:
the fuel data is received from a fuel data communicator associated with a fueling station.

17. The system of claim 16, wherein:
an RF signal indicating the fuel data is received from the fuel data communicator.

18. The system of claim 16, wherein:
the receiving includes reading a machine-readable representation of data indicating the fuel data; and
the fuel data communicator comprises the machine-readable representation of data.

19. The system of claim 16, wherein:
the receiving includes reading alphanumeric characters indicating the fuel data; and
the fuel data communicator comprises the alphanumeric characters.

20. The system of claim 16, wherein:
the fuel data is received from a website associated with the fueling station.

21. The system of claim 15, wherein:
the fuel data is received via a user input indicating the fuel data.

22. The system of claim 15, wherein:
the fuel data corresponds to at least one type of data selected from a group consisting of a fuel price and a grade of fuel desired for use in the vehicle.

23. The system of claim 15, wherein:
the visual indicator is visible to a person located outside of the vehicle while the person is adjacent to a fuel receiving nozzle through which fuel is added to the fuel tank.

24. The system of claim 15, wherein:
the fuel data is received for a plurality of fueling stations;
the cost to fill the fuel tank is determined for each of the fueling stations; and
the visual indicator indicates the cost to fill the fuel tank at each of the fueling stations.

25. The system of claim 24, wherein the processor further is configured to initiate executable operations comprising:
for each of the fueling stations:
determining an approximate amount of fuel that will be used by the vehicle to travel to the fuel station;
based at least on the amount of fuel, determining an approximate cost of the fuel that will be used; and
adding the approximate cost of the fuel that will be used to the cost to fill the fuel tank at that fuel station to determine a total cost associated with the fuel station; and
presenting a visual indicator indicating the total cost.

26. The system of claim 25, wherein the processor further is configured to initiate executable operations comprising:
presenting a recommendation of which fueling station is associated with the lowest total cost.

27. The system of claim 25, wherein the processor further is configured to initiate executable operations comprising:
sorting the fueling stations in a hierarchical order based on total cost; and
presenting a list of the fueling stations sorted in the hierarchical order.

28. The system of claim 27, wherein:
the list indicates the cost of fuel at each of the fueling distance and the distance to each fueling station from the vehicle's present location.

29. A computer program product comprising a computer-usable storage medium having stored therein computer-usable program instructions for indicating a cost to fill a fuel tank of a vehicle, the computer-usable program instructions, which when executed by a computer hardware system, causes the computer hardware system to perform:
receiving from a fuel level sending unit a signal indicating a level fuel contained in the fuel tank of the vehicle;
based on the level of fuel contained in the fuel tank, via a processor, determining a quantity of fuel required to fill the fuel tank;
receiving fuel data;
based on the quantity of fuel required to fill the fuel tank and the fuel data, determining the cost to fill the fuel tank; and
presenting a visual indicator indicating the cost to fill the fuel tank.
